(19) United States
(12) Patent Application Publication
(10) Pub. No.: US 2022/0146970 A1
(43) Pub. Date: May 12, 2022

(54) IMAGE FORMING APPARATUS

(71) Applicant: CANON KABUSHIKI KAISHA, Tokyo (JP)

(72) Inventors: Saeko Oishi, Kanagawa (JP); Masahiro Makino, Ibaraki (JP)

(21) Appl. No.: 17/519,421

(22) Filed: Nov. 4, 2021

(30) Foreign Application Priority Data
Nov. 12, 2020 (JP) 2020-188975

(51) Int. Cl. G03G 15/20

(52) U.S. Cl. CPC G03G 15/2039

(57) ABSTRACT

An image forming apparatus includes an image forming unit configured to form an image on an image carrier, a transfer unit configured to transfer the image from the image carrier to a recording medium, a fixing unit configured to fix the image on the recording medium, a reader configured to read the image on the recording medium downstream of the fixing unit in a conveyance direction, and a controller configured to control the image forming unit to form the image and a pattern image, control the transfer unit to transfer the image and the pattern image to a recording medium, control the fixing unit to fix the image and the pattern image on the recording medium, control the reader to read the pattern image on the recording medium, and generate a image forming condition based on a result of the patter image read by the reader.

### BACKGROUND OF THE DISCLOSURE

### Field of the Disclosure

the aspect of the embodiments relates to tone correction control to adjust the density of an image to be formed by an image forming apparatus.

### Description of the Related Art

the density of images formed by an electrophotographic image forming apparatus is changed due to varying environment and wore parts. To bring the tone characteristics of images formed by the image forming apparatus to the ideal, the image forming apparatus performs tone correction control using pattern images.

The tone correction control performs adjustment of parameters for the image forming apparatus to form images based on a result from measurements made on pattern images on a recording medium or an image carrier by a measurement unit. United States Patent Application Publication No. 2017/0242385 discusses a conversion condition for conversion of signal values (tone values) of image data as an example of the parameters. Such tone correction control forms pattern images on a recording medium or an image carrier, keeping tone characteristics ideal even during a print job execution.

The tone correction control that forms pattern images on a recording medium however can control the image forming condition based on wrong output values output from a reader (sensor) with an anomaly or via a recording medium with different properties. In that case, tone characteristics on images formed by the image forming apparatus are not ideal.

### SUMMARY OF THE DISCLOSURE

According to an aspect of the disclosure, an image forming apparatus includes an image forming unit configured to form an image on an image carrier based on an image forming condition, a transfer unit configured to transfer the image from the image carrier to a recording medium, a fixing unit configured to fix the image on the recording medium, a reader configured to read the image on the recording medium downstream of the fixing unit in a conveyance direction in which the recording medium is conveyed, and a controller configured to control the image forming unit to form the image and a pattern image, control the transfer unit to transfer the image and the pattern image to a same recording medium, control the fixing unit to fix the image and the pattern image on the same recording medium, control the reader to read the pattern image on the same recording medium, and generate the image forming condition based on a result of the patter image read by the reader. In a case where a plurality of images is formed on a plurality of recording media of a same type, the controller acquires a result of a first recording medium read by the reader, the first recording medium on which a first image included in the plurality of images and a first pattern image are formed, and determines, based on the result of the first recording medium read by the reader, whether to perform processing to generate the image forming condition based on a result of a second pattern image read by the reader, the second pattern image being on a second recording medium, the second recording medium on which a second image included in the plurality of images is to be formed, the second recording medium being subsequent to the first recording medium.

further features of the disclosure will become apparent from the following description of exemplary embodiments with reference to the attached drawings.

### BRIEF DESCRIPTION OF THE DRAWINGS

FIG. 1 is a schematic cross-sectional view of an image forming apparatus.

FIG. 2 is a schematic configuration diagram of a density sensor.

FIG. 3 is a control block diagram of the image forming apparatus.

FIG. 4 is a four-quadrant chart illustrating conversion processing to correct tone values of image data.

FIG. 5 is a schematic view of tone correction patterns formed on a recording medium.

FIG. 6 is a flowchart of tone correction control using the recording medium.

FIG. 7 is a schematic view of tone correction patterns formed on an intermediate transfer member.

FIG. 8 is a flowchart of tone correction control using the intermediate transfer member.

FIG. 9 is a graph illustrating a relationship between positions on the recording medium and density values of paper white.

FIG. 10 is a flowchart of tone correction control according to a first exemplary embodiment.

FIG. 11 is a graph illustrating a relationship between positions on the intermediate transfer member and signal values of positions on a base portion.

FIG. 12 is a flowchart of tone correction control according to a second exemplary embodiment.

### DESCRIPTION OF THE EMBODIMENTS

Elements of one embodiment may be implemented by hardware, firmware, software or any combination thereof. The term hardware generally refers to an element having a physical structure such as electronic, electromagnetic, optical, electro-optical, mechanical, electro-mechanical parts, etc. A hardware implementation may include analog or digital circuits, devices, processors, applications specific integrated circuits (ASICs), programmable logic devices (PLDs), field programmable gate arrays (FPGAs), or any electronic devices. The term software generally refers to a logical structure, a method, a procedure, a program, a routine, a process, an algorithm, a formula, a function, an expression, etc. The term firmware generally refers to a logical structure, a method, a procedure, a program, a routine, a process, an algorithm, a formula, a function, an expression, etc., that is implemented or embodied in a hardware structure (e.g., flash memory, ROM, EROM). Examples of firmware may include microcode, writable control store, micro-programmed structure.

When implemented in software or firmware, the elements of an embodiment may be the code segments to perform the necessary tasks. The software/firmware may include the actual code to carry out the operations described in one embodiment, or code that emulates or simulates the operations. The program or code segments may be stored in a processor or machine accessible medium. The “processor readable or accessible medium” or “machine readable or accessible medium” may include any non-transitory medium that may store information. Examples of the processor readable or machine accessible medium that may store include a storage medium, an electronic circuit, a semiconductor memory device, a read only memory (ROM), a flash memory, an erasable programmable ROM (EPROM), a floppy diskette, a compact disk (CD) ROM, an optical disk, a hard disk, etc. The machine accessible medium may be embodied in an article of manufacture. The machine accessible medium may include information or data that, when accessed by a machine, cause the machine to perform the operations or actions described above. The machine accessible medium may also include program code, instruction or instructions embedded therein. The program code may include machine readable code, instruction or instructions to perform the operations or actions described above. The term “information” or “data” here refers to any type of information that is encoded for machine-readable purposes. Therefore, it may include program, code, data, file, etc.

All or part of an embodiment may be implemented by various means depending on applications according to particular features, functions. These means may include hardware, software, or firmware, or any combination thereof. A hardware, software, or firmware element may have several modules coupled to one another. A hardware module is coupled to another module by mechanical, electrical, optical, electromagnetic or any physical connections. A software module is coupled to another module by a function, procedure, method, subprogram, or subroutine call, a jump, a link, a parameter, variable, and argument passing, a function return, etc. A software module is coupled to another module to receive variables, parameters, arguments, pointers, etc. and/or to generate or pass results, updated variables, pointers, etc. A firmware module is coupled to another module by any combination of hardware and software coupling methods above. A hardware, software, or firmware module may be coupled to any one of another hardware, software, or firmware module. A module may also be a software driver or interface to interact with the operating system running on the platform. A module may also be a hardware driver to configure, set up, initialize, send and receive data to and from a hardware device. An apparatus may include any combination of hardware, software, and firmware modules.

### (Configuration of Image Forming Apparatus)

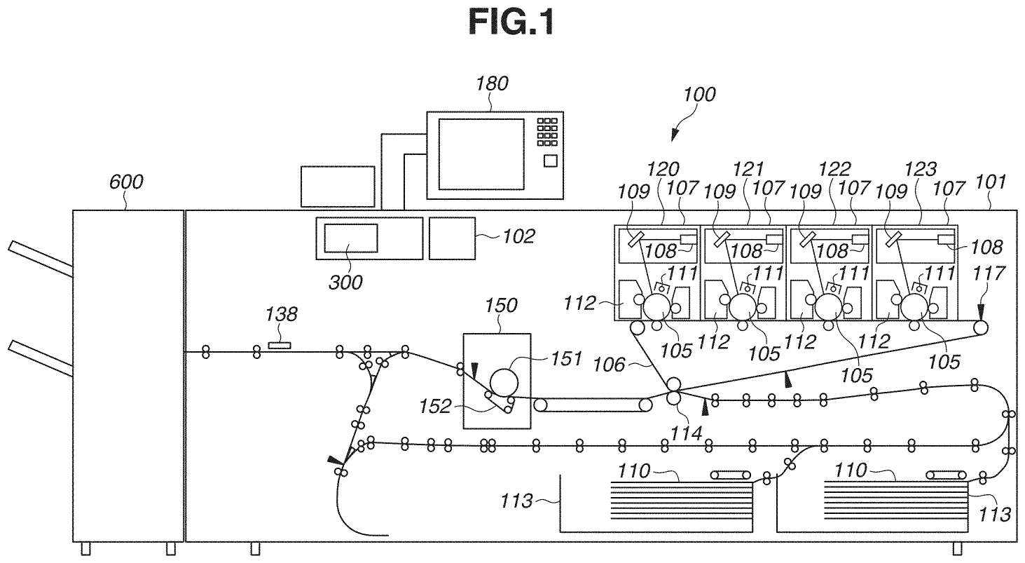

FIG. 1 is a schematic cross-sectional view of an image forming apparatus 100. The image forming apparatus 100 includes a printer 101 to form images on recording media 110, and a post-processing apparatus 600 to perform post-processing on the recording media 110 supplied from the printer 101. A central processing unit (CPU) 102 is a processor to control units of the image forming apparatus 100. A printer controller 300 performs image processing on image data transferred from a host computer.

The printer 101 includes four image forming units 120, 121, 122, and 123. The image forming unit 120 forms yellow images, the image forming unit 121 forms magenta images, the image forming unit 122 forms cyan images, and the image forming unit 123 forms black images.

The image forming unit 120 includes a photosensitive drum 105, a charging unit 111 to charge the photosensitive drum 105, an exposure device 107 to expose the charged photosensitive drum 105 to form an electrostatic latent image on the photosensitive drum 105, and a developing unit 112 to develop the electrostatic latent image on the photosensitive drum 105. The charging unit 111 includes, for example, a charging wire to which a charging voltage is applied. The charging unit 111 is not limited to the configuration including the charging wire, and may have a configuration including a charging roller to which a charging voltage is applied. The exposure device 107 includes a laser light source 108, and a mirror 109 deflecting light from the laser light source 108. Further, the developing unit 112 develops the electrostatic latent image with a developer such as toner. The developing unit 112 consumes the toner while forming images. The printer 101 includes a replenishing mechanism (not illustrated) to replenish the toner from a toner container (not illustrated) to the developing unit 112. Each of the image forming units 121, 122, and 123 has a similar configuration except for the color of the toner. Descriptions of the image forming units 121, 122, and 123 will thus be omitted.

Images each formed by the image forming units 120, 121, 122, and 123, respectively, are transferred, with the images superimposed on the intermediate transfer member 106 as one image. The intermediate transfer member 106 functions as an image carrier carrying the image. The intermediate transfer member 106 includes a belt stretched around a plurality of rollers. The intermediate transfer member 106 according to the present exemplary embodiment uses the belt; however, the intermediate transfer member 106 may use, for example, a roller carrying the images of the respective colors.

The printer 101 includes a transfer roller 114 to be pressed against the intermediate transfer member 106 to form a transfer nip portion. A transfer voltage is applied to the transfer roller 114. The printer 101 further includes a storage 113 to store the recording media 110. The recording media 110 in the storage 113 is fed one by one, and each is conveyed toward the transfer nip portion. As the recording medium 110 and the image on the intermediate transfer member 106 pass through the transfer nip portion, the image on the intermediate transfer member 106 is transferred to the recording medium 110.

The printer 101 includes a fixing unit 150 to fix and fix the transferred image on the recording medium 110. The fixing unit 150 includes a heater (not illustrated), a fusing roller 151, and a pressurization belt 152. The recording medium 110 with the transferred image thereon passes through the fusing nip formed between the fusing roller 151 and the pressurization belt 152. Heat by the heater and pressure at the fusing nip on the recording medium 110 passing through the fusing nip fixes the image on the recording medium 110.

The recording medium 110 with the image fixed thereon is conveyed to the post-processing apparatus 600 connected to the rear stage of the printer 101, and is placed on a tray of the post-processing apparatus 600.

Further, a line sensor 138 is provided downstream of the fixing unit 150 in the conveyance path of conveyance of the recording medium 110 in the printer 101. The line sensor 138 is an optical sensor including a plurality of light receiving devices arranged in a predetermined direction. The line sensor 138 according to the present exemplary embodiment is installed in the printer 101 in the predetermined direction orthogonal to the conveyance direction of the recording medium 110. The line sensor 138 measures pattern images formed on the recording medium 110.

The printer 101 further includes an optical sensor (hereinafter, density sensor) 117 to measure pattern images on the intermediate transfer member 106. The density sensor 117 measures pattern images different from pattern images measured by the line sensor 138.

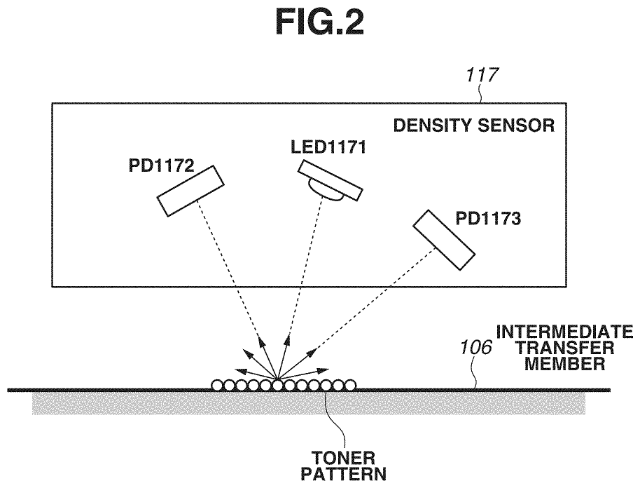

FIG. 2 is a schematic configuration diagram of the density sensor 117. The density sensor 117 is disposed facing the intermediate transfer member 106, and detects pattern images formed on the intermediate transfer member 106. The density sensor 117 includes a light-emitting diode (LED) 1171 and photodiodes (hereinafter, PDs) 1172 and 1173, and detects reflected light. The LED 1171 is a light emitting device to emit light to the intermediate transfer member 106 at an incident angle of 15 degrees. The PD 1172 is a light receiving device to receive light reflected off the intermediate transfer member 106 (or the pattern image) at a reflection angle of 15 degrees. The PD 1173 is a light receiving device provided at a position to receive diffused reflected light off the intermediate transfer member 106 (or pattern image). This arrangement allows the density sensor 117 to measure both the regular reflected light and the diffused reflected light. The PD 1172 to receive the regular reflected light and the PD 1173 to receive the diffused reflected light each output a voltage corresponding to the intensity of the received light (quantity of received light) as an output value.

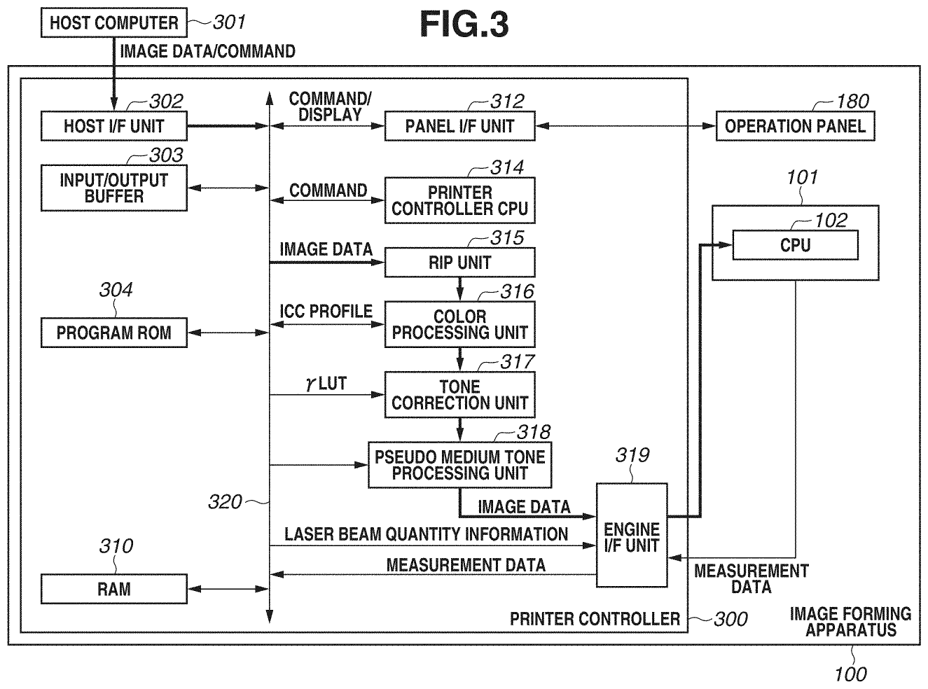

The CPU 102 (FIG. 3) of the image forming apparatus 100 converts the voltage output from the density sensor 117 into information about a density based on a density conversion table for the density sensor 117. Further, the CPU 102 (FIG. 3) of the image forming apparatus 100 converts a sensor output value output from the line sensor 138 into information about a density based on a luminance density conversion table. The luminance density conversion table is different from the density conversion table for the density sensor 117. The above-described configuration allows the CPU 102 (FIG. 3) of the image forming apparatus 100 to acquire the information about the density whichever sensor, the density sensor 117 or the line sensor 138, is used.

### (Configuration of Image Processing Unit)

FIG. 3 is a control block diagram of the image forming apparatus 100. A host computer 301 transmits image data to the image forming apparatus 100 through a communication line, and outputs a command to instruct start of image formation to the image forming apparatus 100.

The printer controller 300 includes a printer controller CPU 314, a program read only memory (ROM) 304, and a random access memory (RAM) 310 used as a system work memory. The printer controller 300 further includes a host interface (I/F) unit 302 to govern input/output to and from the host computer 301, an input/output buffer 303 to perform transmission/reception of control codes and data, and an engine I/F unit 319 used in transmission/reception of data to and from the printer 101. A raster image processor (RIP) unit 315 rasterizes the image data transferred from the host computer 301 into a bitmap image. A color processing unit 316 performs multinary color conversion processing described below. A tone correction unit 317 converts signal values of the image data based on a γ look-up table (γLUT) for the tone characteristics of the image to be formed by the printer 101 to be ideal. A pseudo medium tone processing unit 318 performs pseudo medium tone processing such as a dither matrix and an error diffusion method.

Measurement operation using the line sensor 138 or the density sensor 117 is controlled by the CPU 102.

The printer controller 300 includes an operation panel 180 to operate the printing apparatus and to instruct the execution of the above-described correction processing, a panel I/F unit 312 to perform input/output of information between the printer controller 300 and the operation panel 180, and a system bus 320.

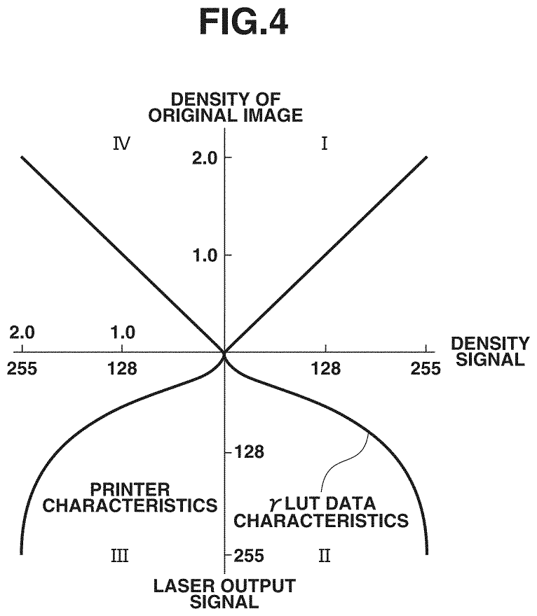

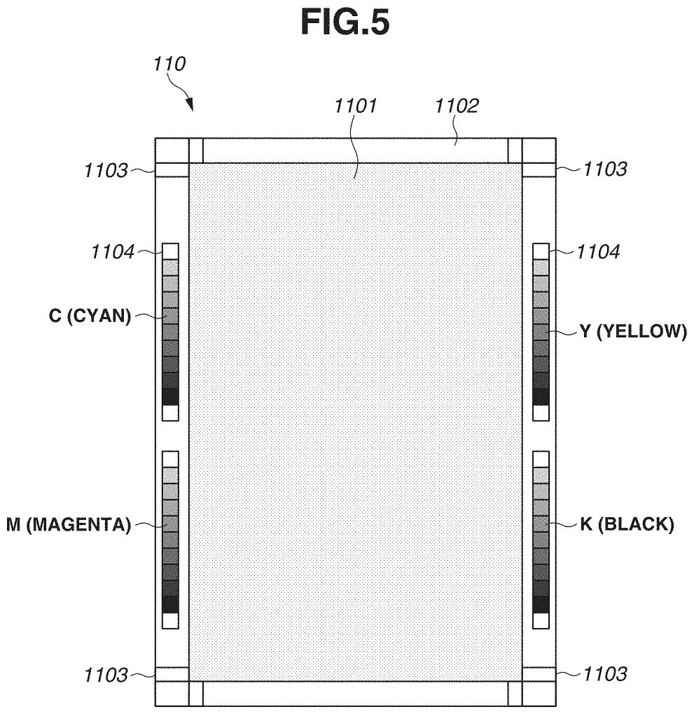

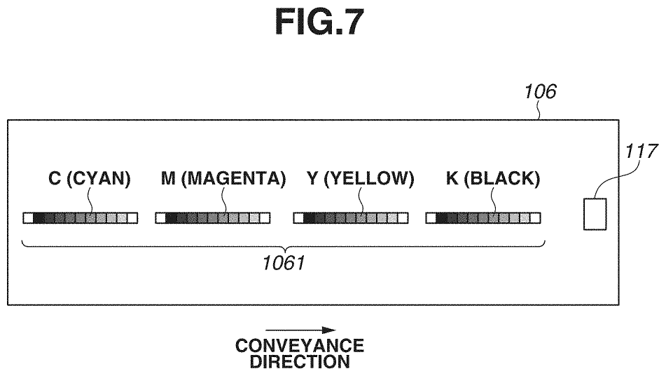

The tone correction control performed by the image forming apparatus 100 while a print job to form an image on the recording medium 110 is carried out will be described. The following is a description of two methods: one method of performing the tone correction with tone correction patterns 1104 (FIG. 5) formed on the recording medium 110 and the other method of performing the tone correction with tone correction patterns 1061 (FIG. 7) formed on the intermediate transfer member 106. The outline of the tone correction control will be described with reference to FIG. 4 first.

### (Outline of Tone Correction Control)

FIG. 4 is a four-quadrant chart illustrating the reproduction of tones. The first quadrant illustrates reading characteristics of a sensor to convert the density of an original image into a density signal, and the second quadrant illustrates conversion characteristics (data characteristics) of a γLUT for conversion of the density signal into a laser output signal. Further, the third quadrant illustrates recording characteristics (printer characteristics) of the printer unit to converts the laser output signal into the density of the output image, and the fourth quadrant illustrates the relationship between the density of the original image and the density of the output image. In other words, the four-quadrant chart of FIG. 4 illustrates the total tone reproduction characteristics of the image forming apparatus 100 illustrated in FIG. 1. The chart illustrates a case of an 8-bit signal, or 256 tones as the number of tones, used in processing. Examples of a sensor in the first quadrant includes the line sensor 138 to read tone correction patterns on a recording medium 110 and the density sensor 117 to read tone correction patterns on the intermediate transfer member 106. To linearize final tone characteristics by the image forming unit of the image forming apparatus 100, namely, tone characteristics in the fourth quadrant, the nonlinear portions of the printer characteristics in the third quadrant are corrected based on the γLUT in the second quadrant. The image signal, the tone characteristics that have been converted based on the γLUT, is converted into a pulse signal corresponding to a dot width by a pulse width modulation (PWM) circuit of the laser driver, and the pulse signal is transmitted to an LD driver to control on/off of the laser light source 108.

Further, laser light from the laser light source 108 scans the photosensitive drum 105, forming an electrostatic latent image having predetermined tone characteristics with varying dot areas based on controlled tones on the photosensitive drum 105, and the tone image is reproduced through the above-described processes of the development, the transfer, and the fusing.

(Tone Correction with Formation of Tone Correction Pattern on Recording Medium)

FIG. 5 is a diagram illustrating the recording medium 110 with an image and the tone correction patterns 1104 formed thereon. In the recording medium 110 as an example illustrated in FIG. 5, there are an image area 1101 in which an image is formed, and a non-image area 1102 between the image area 1101 and the edge of the recording medium 110. The image area 1101 is an area indicated by dots in FIG. 5, and includes an image section in which an image desired by a user is formed, and cutting marks 1103 previously provided around the image section by the user. The cutting marks 1103 each are formed of two overlapped L-shaped marks near four corners of the image section, and a portion surrounded by the four cutting marks 1103 forms a cutting position of the recording medium 110.

The dots indicating the image area 1101 in FIG. 5 are illustrated for description, and are not actually formed on the recording medium 110. Further, the recording medium 110 illustrated in FIG. 5 is passed in the longitudinal direction of the recording medium 110.

As illustrated in FIG. 5, the tone correction pattern 1104 in each of the colors C, M, Y, and K is formed on one of the surfaces of the recording medium 110. The tone correction patterns 1104 are normally formed in the non-image area 1102 outside the image area 1101 to avoid overlapping with the image area 1101; however, if the CPU 314 determines that the tone correction patterns 1104 will be formed overlapping with the image area 1101, the tone correction patterns 1104 are formed overlapping with the image area 1101. In the exemplary embodiment of the disclosure, cases of the tone correction patterns 1104 overlapping with the image area 1101 includes a case where the tone correction patterns 1104 are formed from the non-image area 1102 into the image area 1101, as well as a case where the tone correction patterns 1104 are formed overlapping with the image area 1101.

Although the tone correction patterns 1104 can be formed on any of peripheral edge portions of the recording medium 110, the tone correction patterns 1104 are formed on end areas of the recording medium 110 in the direction orthogonal to the conveyance direction of the recording medium 110 as illustrated in FIG. 5. According to the present exemplary embodiment, the cyan and magenta tone correction patterns 1104 are in one of the end areas of the recording medium 110; the yellow and black tone correction patterns 1104 are in the other end area of the recording medium 110. The end areas of the recording medium 110 are to be cut off. For example, a cutting machine separate from the image forming apparatus 100 cuts off the end areas of the recording medium 110. As a result, the tone correction patterns 1104 are not left in the final product.

The tone correction patterns 1104 in each color of the colors C, M, Y, and K includes a plurality of patch images (nine patch images in illustrated example) stepwise different in tone value. For example, each of the patch images forms a square shape with a side length of about 10 mm, and the patch images in each color are arranged in line in the conveyance direction of the recording medium 110. The individual tone values (0 to 255) of the patch images in each color are, for example, 16, 32, 64, 86, 104, 128, 176, 224, and 255.

The tone correction control with the formation of the tone correction patterns 1104 on the recording medium 110 is performed by the CPU 102 controlling the line sensor 138, and the tone correction unit 317 adjusts the tone characteristics of the image formed by the printer 101. In other words, after the color processing unit 316 performs initial adjustment of the color correction processing, the tone correction unit 317 performs calibration every sheet passing through the printer 101. The tone correction patterns 1104 formed in the non-image area 1102 on the recording medium 110 as illustrated in FIG. 5 allows the tone correction to be performed every time one sheet is output.

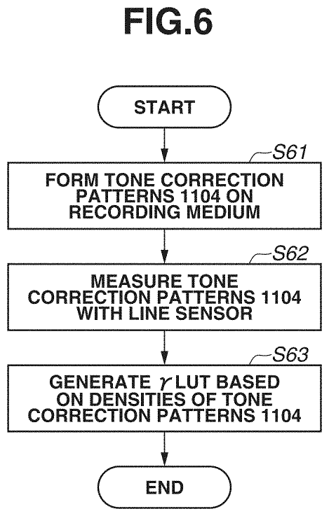

FIG. 6 illustrates an example of a flowchart of the tone correction control with the formation of the tone correction patterns 1104 on a recording medium 110. When a user issues an instruct to perform the tone correction control using the operation panel 180, the CPU 102 reads out a program for the tone correction control from the ROM 304, and performs the tone correction control in FIG. 6. First, in step S61, the CPU 102 controls the printer 101 to form an image of the user and the tone correction patterns 1104 on the recording medium 110. Next, in step S62, the CPU 102 controls the line sensor 138 to measure the tone correction patterns 1104. Further, in step S63, the CPU 102 generates a γLUT based on the measurement result of the tone correction patterns 1104. The generation of the γLUT is outlined as described with reference to FIG. 4. After the γLUT is generated in step S63, image data on the image of the user is converted based on the generated γLUT, and the image of the user is formed based on the converted image data. This enables the image forming apparatus 100 to control the density of the image of the user to the ideal.

As described above, the tone correction patterns 1104 formed in the non-image area 1102 on the recording medium 110 allows the tone correction control to be performed without stopping the print job.

(Tone Correction with Formation of Tone Correction Pattern 1061)

FIG. 7 is a schematic view of the tone correction patterns 1061 formed on the intermediate transfer member 106 and a top view of the intermediate transfer member 106. The tone correction patterns 1061 are formed at the attached position of the density sensor 117 facing the intermediate transfer member 106. As with the tone correction patterns 1104 formed on the recording medium 110, the tone correction patterns 1061 in each color formed on the intermediate transfer member 106 includes a plurality of patch images (11 patches in illustrated example) stepwise different in tone value. For example, each of the patch images has a square shape with a side length of about 10 mm, and the patch images in each color are arranged in line in the moving direction (rotation direction) of the intermediate transfer member 106. The individual tone values (0 to 255) of the patch images in each color are, for example, 16, 32, 64, 86, 104, 128, 176, 224, and 255. The tone correction patterns 1061 are arranged in one line in FIG. 7; however, with a plurality of density sensors 117 installed in the main scanning direction, the tone correction patterns 1061 may be arranged in a plurality of lines.

The tone correction control with formation of the tone correction patterns 1061 on the intermediate transfer member 106 is performed by the CPU 102 controlling the density sensor 117, and the tone correction unit 317 adjusts the tone characteristics of the image formed by the printer 101. In other words, after the color processing unit 316 performs initial adjustment of the color correction processing, the tone correction unit 317 performs calibration every time the printer 101 forms images on a predetermined number of pages. The predetermined number of pages is, for example, 100 pages. As illustrated in FIG. 7, the tone correction patterns 1061 are formed when the image forming apparatus 100 does not form an image. Thus, the image forming apparatus 100 forms the tone correction patterns 1061 every time the image forming apparatus 100 forms images on the predetermined number of pages, or forms the tone correction patterns 1061 after the print job ends.

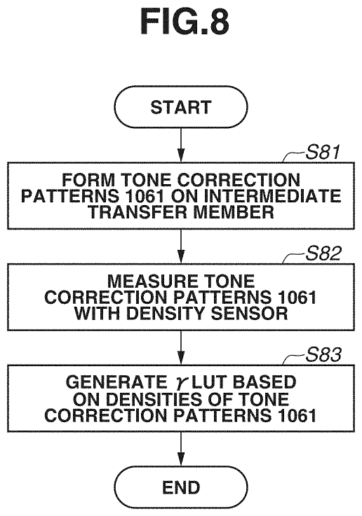

FIG. 8 illustrates an example of a flowchart of the tone correction control with formation of the tone correction patterns 1061 on the intermediate transfer member 106. The CPU 102 reads out a program for the tone correction control from the ROM 304 to form the tone correction patterns 1061 every time the number of images formed on the intermediate transfer member 106 reaches a predetermined number, and performs the tone correction control in FIG. 8. The predetermined number is set to, for example, 100. First, in step S81, the CPU 102 controls the printer 101 to form the tone correction patterns 1061 on the intermediate transfer member 106. Next, in step S82, the CPU 102 controls the density sensor 117 to measure the tone correction patterns 1061. In step S82, the voltages output from the density sensor 117 are converted into density values based on the density conversion table for the density sensor 117. Thereafter, in step S83, the CPU 102 generates a γLUT based on the measurement result of the tone correction patterns 1061.

A method will be described of updating the γLUT of the recording medium 110 based on the density values of the tone correction patterns 1061 on the intermediate transfer member 106. When target tone reproduction characteristics are provided on the recording medium 110 (e.g., immediately after an automatic tone correction control is optionally performed), the CPU 102 forms the tone correction patterns 1061 on the intermediate transfer member 106 and holds the tone correction patterns 1061 as target tones. The above-described automatic tone correction control is not the tone correction control performed during a print job but the tone correction control performed at an optional timing desired by the user to generate a γLUT for the image tone characteristics of each color to be ideal. The automatic tone correction control uses 16 tone patch images in each color formed on the recording medium 110, allowing the tone characteristics to be adjusted with higher accuracy than the tone correction control with formation of the tone correction patterns 1104 is performed. The CPU 102 determines actual tone characteristics based on the density values of the tone correction patterns 1061 to generate a conversion LUT with the actual tone characteristics as the target tones. Further, the CPU 102 generates a γLUT by combining the conversion LUT with the γLUT generated in the automatic tone correction control.

After the γLUT is generated in step S83, image data on the user image is converted based on the generated γLUT, and the image of the user is formed based on the converted image data. This enables the image forming apparatus 100 to adjust the density of the user image to the ideal density.

As described above, the tone correction patterns 1061 are formed when the image forming apparatus 100 does not form an image. Thus, the image forming apparatus 100 forms the tone correction patterns 1061 by interrupting the print job every time the image forming apparatus 100 forms images on the predetermined number of recording media 110, or after the print job ends. The tone correction with formation of the tone correction patterns 1061 can control the tone characteristics without using the recording medium 110 even though the productivity is inferior to that through the tone correction with formation of the tone correction patterns 1104.

The tone correction control has been described of correcting the tones formed by the image forming apparatus 100 with the tone correction patterns 1104 or the tone correction patterns 1061 formed. Both can sequentially correct the tone characteristics of the image formed by the printer 101 during the print job. The tone correction control based on the measurement result of the tone correction patterns 1104 on the recording medium 110 acquires the measurement result of the image formed on the recording medium 110 as the final product, offering a high accuracy correction on the tone characteristics. However, the acquired density values from the recording medium 110 may be varied due to changes during an idle state, changes in stiffness of recording media among production lots, or those controlled by other factors. Further, the detection result may be varied due to an accidental error of the line sensor 138.

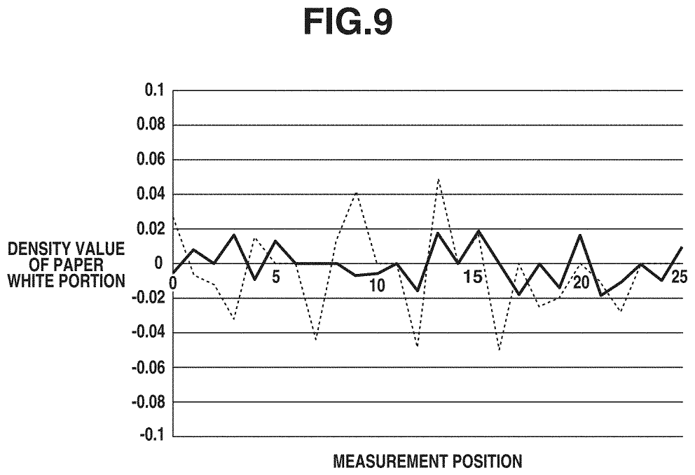

FIG. 9 illustrates a relationship between positions on the recording medium 110 in the conveyance direction and the density values on paper white. The horizontal axis represents each position on the recording medium 110 in the conveyance direction, and the vertical axis represents the corresponding density of the paper white of the recording medium 110. The solid line represents the result of the density values of the paper white of a recording medium with a small variation in density of the paper white. The dashed line represents the result of the density values of the paper white of a recording medium with a large variation in density of the paper white. In FIG. 9, the density differences in the values of the solid line range within 0.04, whereas the density differences in the values of the dashed line range greater than or equal to 0.04. With the tone correction patterns 1104 formed on the dashed line recording medium, the variations in the densities of the paper white affect densities of the pattern image. This can present a worse correction accuracy in the tone correction control. The image forming apparatus 100 according to the present exemplary embodiment selects the better type of the tone correction control from the tone correction control with formation of the tone correction patterns 1104 and the tone correction control with formation of the tone correction patterns 1061, depending on the variations in the densities of the paper white of the recording medium 110.

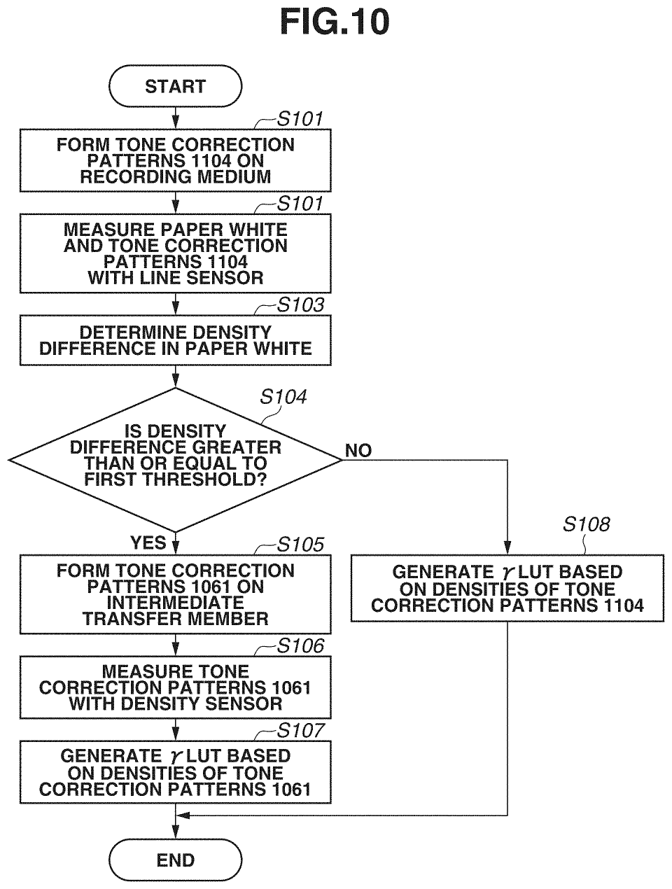

The following is a description of the tone correction control according to the first exemplary embodiment with reference to a flowchart illustrated in FIG. 10. In step S101, the CPU 102 first controls the printer 101 to form the image of the user and the tone correction patterns 1104 on the same recording medium 110. In step S102, the CPU 102 controls the line sensor 138 to measure the paper white and the tone correction patterns 1104 of the recording medium 110. In step S102, the sensor outputs from the line sensor 138 are converted into density values based on the luminance density conversion table. Next, in step S103, the CPU 102 calculates the differences between the densities of the paper white acquired in step S102.

A density difference ΔW1s of the paper white on one of the end areas of the recording medium 110 is determined based on an expression (1),

ΔW1s=MAX(|C1s−C2s|,|C1s−M1s|,|C1s−M2s|,|C2s−M1s|,|C2s−M2s|,|M1s−M2s|). (1)

In the expression, C1s and C2s are densities of the paper white at the leading and trailing portions of the C (cyan) tone correction pattern 1104 in the conveyance direction, respectively. Likewise, M1s and M2s are densities of the paper white at the leading and trailing portions of the M (magenta) tone correction pattern 1104 in the conveyance direction, respectively.

Further, a density difference ΔW2s of the paper white on the other end area of the recording medium 110 is determined based on an expression (2),

ΔW2s=MAX(|Y1s−Y2s|,|Y1s−K1s|,|Y1s−K2s|,|Y2s−K1s|,|Y2s−K2s|,|K1s−K2s|). (2)

In the expression, Y1s and Y2s are densities of the paper white at the leading and trailing portions of the Y (yellow) tone correction pattern 1104 in the conveyance direction, respectively. Likewise, K1s and K2s are densities of the paper white at the leading and trailing portions of the K (black) tone correction pattern 1104 in the conveyance direction, respectively.

The CPU 102 functions as a determination unit to determine a plurality of density differences of the paper white. The CPU 102 determines a difference ΔW between the densities of the paper white based on an expression (3),

ΔW=MAX(ΔW1s,ΔW2s). (3)

The expression (1) and the expression (2) are used to calculate the maximum density difference values of the paper white on the different end areas in the direction orthogonal to the conveyance direction of the recording medium 110. The expression (3) is used to select the larger one as the difference ΔW of the maximum density difference values, ΔW1s of the paper white in one of the end areas and ΔW2s of the paper white in the other end area. As a result, the CPU 102 extracts the largest density difference value of the paper white in one recording medium 110.

Next, in step S104, the CPU 102 determines whether the value of the difference ΔW is greater than or equal to a first threshold. The first threshold is set to, for example, 0.04. If the value of the difference ΔW is greater than or equal to the first threshold, the CPU 102 determines that the variation in the detection result of the recording medium 110 is large. With the value of the difference ΔW greater than or equal to the first threshold, the CPU 102 determines that a γLUT will be generated based on a measurement result of the tone correction patterns 1061 formed on the intermediate transfer member 106.

Even if the variation in the detection result is less than the first threshold at the start of a print job, the variation in the detection result may become greater than or equal to the first threshold during the print job due to changes in the state of the recording media 110 out of use during the print job or an accidental error of the line sensor 138. Continued tone correction using the recording medium 110 with that variation can present a worse accuracy.

If the value of the difference ΔW is greater than or equal to the first threshold, the CPU 102 stops the tone correction control with formation of the tone correction patterns 1104, and starts the tone correction control with formation of the tone correction patterns 1061. The CPU 102 selects whether to continue the tone correction control with formation of the tone correction patterns 1104 or to perform the tone correction control with formation of the tone correction patterns 1061, based on the determination result.

If the value of the difference ΔW is greater than or equal to the first threshold in step S104 (YES in step S104), the CPU 102 controls the printer 101 to form the tone correction patterns 1061 on the intermediate transfer member 106 in step S105. At this time, the CPU 102 does not generate a γLUT based on the reading result of the tone correction patterns 1104 read by the line sensor 138. Next, in step S106, the CPU 102 controls the density sensor 117 to measure the tone correction patterns 1061. In step S106, the voltages output from the density sensor 117 are converted into the density values based on the density conversion table for the density sensor 117. At this time, if the value of the difference ΔW is greater than or equal to the first threshold in step S104, the CPU 102 controls the printer 101 not to form the tone correction patterns 1104. Further, in step S107, the CPU 102 generates a γLUT based on the measurement result of the tone correction patterns 1061. The CPU 102 forms the tone correction patterns 1061 and generates a γLUT every time images are formed on the predetermined number of (e.g., 100) recording media 110.

The variation in the detection result of the recording medium 110 generated due to characteristic changes of the recording medium 110 or an error of the line sensor 138 does not affect the measurement result of the tone correction patterns 1061 on the intermediate transfer member 106. Even if variations occur in the detection result of the recording medium 110, continued tone correction control with formation of the tone correction patterns 1061 is performable, preventing the deterioration of the correction accuracy.

If the value of the difference ΔW is less than the first threshold in step S104 (NO in step S104), the CPU 102 generates a γLUT based on the measurement result of the tone correction patterns 1104 in step S108. Thereafter, the CPU 102 repeatedly performs the processing from step S101 every time a recording medium 110 passes through the measurement position of the line sensor 138.

If the value of the difference ΔW is greater than or equal to the first threshold in step S104, formation of the tone correction patterns 1104 in the non-image area 1102 on the recording medium 110 may be canceled or continued. In terms of the reduction in the toner amount, the formation of the tone correction patterns 1104 is canceled.

As described above, the image forming apparatus 100 according to the present exemplary embodiment performs the tone correction control using the recording medium 110 if the density difference determined from the plurality of paper white portions of the recording medium 110 is less than the first threshold. In contrast, if the density difference determined from the plurality of paper white portions of the recording medium 110 is greater than or equal to the first threshold, the image forming apparatus 100 according to the present exemplary embodiment determines that the variation in the detection result of the recording medium 110 is large, and shifts the tone correction control to the tone correction control using the intermediate transfer member 106. The image forming apparatus 100 according to the present exemplary embodiment prevents deterioration of the correction accuracy even if any abnormality to deteriorate the correction accuracy of the tone correction control occurs.

Further, the disclosure is not limited to the configuration in which the CPU 102 controls the printer 101 not to form the tone correction patterns 1104 with the value of the difference ΔW greater than or equal to the first threshold in step S104. If the value of the difference ΔW is greater than or equal to the first threshold, the CPU 102 may form the tone correction patterns 1104, but may control the line sensor 138 not to read the tone correction patterns 1104. Alternatively, if the value of the difference ΔW is greater than or equal to the first threshold, the CPU 102 may control the line sensor 138 to read the tone correction patterns 1104, but may not generate a γLUT based on the reading result of the tone correction patterns 1104 by the line sensor 138. If the value of the difference ΔW acquired from a certain sheet is greater than or equal to the first threshold, the CPU 102 performs control not to generate a γLUT based on the reading result of the tone correction patterns 1104 on a sheet subsequent to the corresponding sheet.

A second exemplary embodiment will be described. The image forming apparatus 100 according to the first exemplary embodiment performs the tone correction using the tone correction patterns formed on the recording medium 110 during a print job. Further, the image forming apparatus 100 according to the first exemplary embodiment shifts the tone correction to the tone correction using the intermediate transfer member 106 if variations in the detection result in the area not provided with the tone correction patterns of the recording medium 110 occur.

At this time, if the tone correction with formation of the tone correction patterns 1104 is performed with no cutting area (non-image area 1102) on the recording medium 110, the tone correction patterns 1104 could be provided on the recording medium 110 by interrupting the print job. However, the recording medium 110 is used to print the tone correction patterns 1104. Thus, there is a need to perform the tone correction control with formation of the tone correction patterns 1061 instead of the tone correction control with formation of the tone correction patterns 1104. On the other hand, performing the tone correction control with formation of the tone correction patterns 1061 can entail variations in the detection result of the density sensor due to a scratch, a deformation, stain, and other sources on the intermediate transfer member 106.

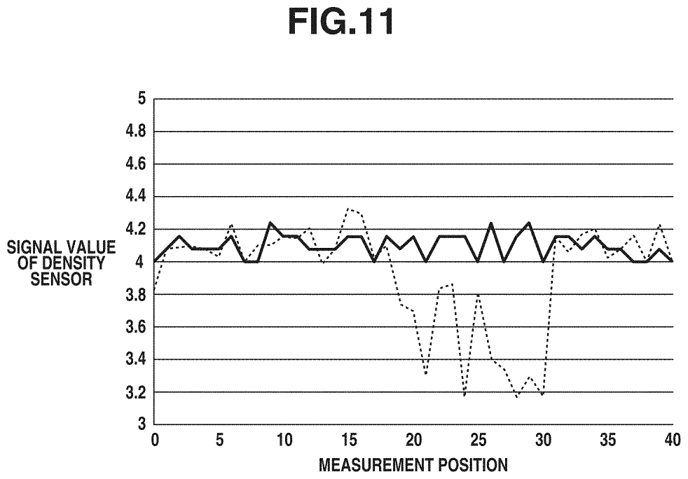

FIG. 11 illustrates a relationship between each position on the intermediate transfer member 106 and the corresponding detection result of non-image area on the intermediate transfer member 106 (hereinafter, referred to as a base portion). The horizontal axis represents positions on the intermediate transfer member 106 in the moving direction (rotation direction), and the vertical axis represents values obtained by regular reflected light off the base portion of the intermediate transfer member 106 being read by the density sensor 117. The solid line represents a detection result of the intermediate transfer member 106 without stain, and the dashed line represents a detection result of the intermediate transfer member 106 with stain.

Because the regular reflected light component off the base portion of the intermediate transfer member 106 is higher, stain thereon lowers the regular reflected light component. On the dashed line in FIG. 11, the values read by the density sensor 117 are low at portions (20 to 30 on the horizontal axis) with stain on the intermediate transfer member 106. Continued tone correction control with formation of the tone correction patterns 1061 on the intermediate transfer member 106 with the result indicated by the dashed line can deteriorate the correction accuracy due to the variations in the detection result of the base portion.

To solve this issue, the image forming apparatus 100 according to the second exemplary embodiment shifts the tone correction control to the tone correction control with formation of the tone correction patterns 1104 on the recording medium 110 in response to the occurrence of variations in the detection result of the base portion of the intermediate transfer member 106. The image forming apparatus 100 according to the second exemplary embodiment has a configuration similar to that of the image forming apparatus 100 according to the first exemplary embodiment except for details of the processing. In the following, differences between the processing in the second exemplary embodiment and that in the first exemplary embodiment will be described.

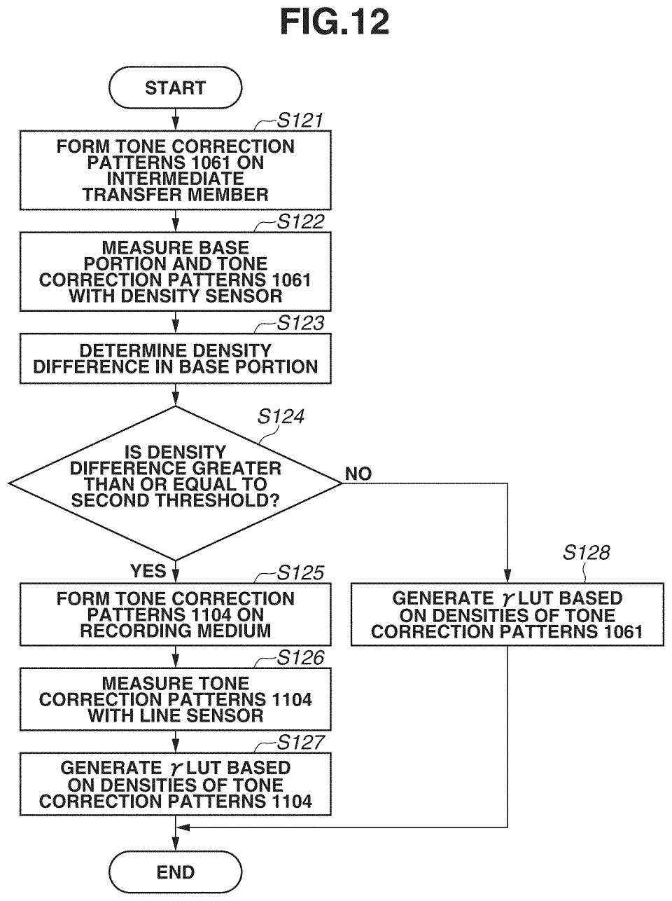

The following is a description of the tone correction control according to the second exemplary embodiment with reference to a flowchart illustrated in FIG. 12. First, in step S121, the CPU 102 controls the printer 101 to form the tone correction patterns 1061 on the intermediate transfer member 106. In step S122, the CPU 102 controls the density sensor 117 to measure the base portion and the tone correction patterns 1061 of the intermediate transfer member 106. In step S122, the voltages output from the density sensor 117 are converted into density values based on the density conversion table for the density sensor 117. Next, in step S123, the CPU 102 calculates differences between the output voltages (signal values) corresponding to the positions on the base portion acquired in step S122. The CPU 102 functions as a determination unit to determine the differences between the output voltages of the positions on the base portion. The CPU 102 acquires measurement results at different positions as the positions on the base portion of the intermediate transfer member 106 in the moving direction (rotation direction) with no patch images.

The positions on the base portion include the area downstream of the black tone correction pattern 1061 in the rotation direction of the intermediate transfer member 106 and the area upstream of the cyan tone correction pattern 1061 in the rotation direction of the intermediate transfer member 106 in FIG. 7. Patch images are not provided on both areas. The positions on the base portion include the area with no patch images formed thereon between the black tone correction pattern 1061 and the yellow tone correction pattern 1061 and the area with no patch images formed thereon between the yellow tone correction pattern 1061 and the magenta tone correction pattern 1061. Likewise, the positions on the base portion include the area with no patch images between the magenta tone correction pattern 1061 and the cyan tone correction pattern 1061.

The CPU 102 determines a difference ΔP between the signal values of the positions on the base portion based on an expression (4),

ΔP=MAX(|K0i−YKi|,|YKi−MYi|,|MYi−YCi|,|YCi−C0i|). (4)

In the expression, K0i is a signal value corresponding to the measurement result of regular reflected light off the area downstream of the black tone correction pattern 1061 in the rotation direction, C0i is a signal value corresponding to the measurement result of regular reflected light off the area upstream of the cyan tone correction pattern 1061 in the rotation direction, YKi is a signal value corresponding to the measurement result of regular reflected light off the area between the black tone correction pattern 1061 and the yellow tone correction pattern 1061, MYi is a signal value corresponding to the measurement result of regular reflected light off the area between the yellow tone correction pattern 1061 and the magenta tone correction pattern 1061, and YCi is a signal value corresponding to the measurement result of regular reflected light off the area between the cyan tone correction pattern 1061 and the yellow tone correction pattern 1061.

The expression (4) is used to calculate the maximum difference value between the signal values corresponding to the measurement results of the regular reflected light off the areas on the intermediate transfer member 106.

Next, in step S124, the CPU 102 determines whether the value of the difference ΔP is greater than or equal to a second threshold. If the value of the difference ΔP is greater than or equal to the second threshold, the CPU 102 determines that the variations in the detection result of the intermediate transfer member 106 are large. As a result, if the value of the difference ΔP is greater than or equal to the second threshold, the CPU 102 determines that a γLUT will be generated based on the measurement result of the tone correction patterns 1104 formed on the recording medium 110.

Even if the variations in the detection result are less than the second threshold at the start of a print job, the variations in the detection result can become greater than or equal to the second threshold during the print job due to an occurrence of stain on the intermediate transfer member 106 during the print job. Continued tone correction on the intermediate transfer member 106 with the stain can present a worse correction accuracy due to variations in the detection result.

If the value of the difference ΔP is greater than or equal to the second threshold, the CPU 102 stops the tone correction control with formation of the tone correction patterns 1061, and starts the tone correction control with formation of the tone correction patterns 1104. The CPU 102 selects whether to continue the tone correction control with formation of the tone correction patterns 1061 or to perform the tone correction control with formation of the tone correction patterns 1104 based on the determination result.

If the value of the difference ΔP is greater than or equal to the second threshold in step S124 (YES in step S124), the CPU 102 controls the printer 101 to form the tone correction patterns 1104 on the recording medium 110 in step S125. At this time, with no cutting areas on the recording medium 110, the tone correction patterns 1104 are formed on another recording medium 110 separate from the recording medium 110 on which the image of the user is to be formed. The CPU 102 displays a selection screen on the operation panel to select whether to perform the tone correction control with formation of the tone correction patterns 1104 on the recording medium 110. If the user selects the tone correction control with formation of the tone correction patterns 1104 on the recording medium 110 on the selection screen of the operation panel 180, the CPU 102 forms the tone correction patterns 1104. In this case, the tone correction is performed by interrupting the print job, for example, at the timing of the processing proceeding to step S125, and then the tone correction is performed by interrupting the print job every predetermined number (e.g., 100 sheets).

Next, in step S126, the CPU 102 controls the line sensor 138 to measure the tone correction patterns 1104. In step S126, the sensor outputs from the line sensor 138 are converted into density values based on the luminance density conversion table. In step S127, the CPU 102 generates a γLUT based on the measurement result of the tone correction patterns 1104. Thereafter, the CPU 102 forms the tone correction patterns 1104 and generates a γLUT every time images are formed on the predetermined number of (e.g., 100) recording media 110.

The variations in the detection result of the intermediate transfer member 106 generated due to stain or other sources on the intermediate transfer member 106 do not affect detection of the tone correction patterns of the recording medium 110. Even if variations in the detection result occur on the intermediate transfer member 106, continued tone correction control using the recording medium 110 is performable. The image forming apparatus 100 according to the present exemplary embodiment keeps the correction accuracy even if any abnormality to deteriorate the correction accuracy of the tone correction control occurs.

If the difference between the signal values corresponding to the measurement results of the regular reflected light off the positions on the base portion of the intermediate transfer member 106 is greater than or equal to the second threshold, the image forming apparatus 100 according to the second exemplary embodiment determines that the variations in the detection result of the intermediate transfer member 106 are large, and shifts the tone correction control to the tone correction control using the recording medium 110. In contrast, if the difference between the signal values is less than the second threshold, the image forming apparatus 100 according to the second exemplary embodiment continues performing the tone correction using the intermediate transfer member 106. As a result, even if variations in the detection result occur due to stain or other sources on the intermediate transfer member 106 during the print job, the image forming apparatus 100 according to the second exemplary embodiment keeps the correction accuracy.

### Other Exemplary Embodiments

The image forming apparatus 100 according to the first exemplary embodiment may resume the tone correction with formation of the tone correction patterns 1104 with the variation in the detection result of a recording medium 110 less than the first threshold even after the start of the tone correction with formation of the tone correction patterns 1061.

The image forming apparatus 100 according to the second exemplary embodiment may resume the tone correction with formation of the tone correction patterns 1061 with the variation in the detection result of the intermediate transfer member 106 less than the second threshold even after the start of the tone correction with formation of the tone correction patterns 1104.

The image forming apparatus 100 according to the first exemplary embodiment and the image forming apparatus 100 according to the second exemplary embodiment generate a γLUT as an image forming condition. However, the intensity of laser light may be determined as an image forming condition based on the reading result of the tone correction patterns 1104 or the measurement result of the tone correction patterns 1061. This configuration also makes it possible to adjust the density of the image formed by the printer 101.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2020-188975, filed Nov. 12, 2020, which is hereby incorporated by reference herein in its entirety.

What is claimed is:

1. An image forming apparatus comprising:
an image forming unit configured to form an image on an image carrier based on an image forming condition;
a transfer unit configured to transfer the image from the image carrier to a recording medium;
a fixing unit configured to fix the image on the recording medium;
a reader configured to read the image on the recording medium downstream of the fixing unit in a conveyance direction in which the recording medium is conveyed; and
a controller configured to:
control the image forming unit to form the image and a pattern image;
control the transfer unit to transfer the image and the pattern image to a same recording medium;
control the fixing unit to fix the image and the pattern image on the same recording medium;
control the reader to read the pattern image on the same recording medium; and
generate the image forming condition based on a result of the patter image read by the reader,
wherein, in a case where a plurality of images is formed on a plurality of recording media of a same type, the controller acquires a result of a first recording medium read by the reader, the first recording medium on which a first image included in the plurality of images and a first pattern image are formed, and determines, based on the result of the first recording medium read by the reader, whether to perform processing to generate the image forming condition based on a result of a second pattern image read by the reader, the second pattern image being on a second recording medium, the second recording medium on which a second image included in the plurality of images is to be formed, the second recording medium being subsequent to the first recording medium.

2. The image forming apparatus according to claim 1, wherein, in response to determination by the controller not to perform the processing to generate the image forming condition based on the result of the second pattern image read by the reader, the second pattern image being on the second recording medium, the second recording medium on which the second image is to be formed, the controller controls the image forming unit not to form the second pattern image.

3. The image forming apparatus according to claim 1, wherein, in response to determination by the controller not to perform the processing to generate the image forming condition based on the result of the second pattern image read by the reader, the second pattern image being on the second recording medium, the controller controls the reader not to read the second pattern image on the second recording medium.

4. The image forming apparatus according to claim 1, further comprising a sensor configured to measure a measurement image on the image carrier,
wherein, in response to determination by the controller not to perform the processing to generate the image forming condition based on the result of the second pattern image read by the reader, the second pattern image being on the second recording medium, the controller controls the image forming unit to form the measurement image, controls the sensor to measure the measurement image, and generates the image forming condition based on a measurement result of the measurement image.

5. The image forming apparatus according to claim 1, wherein the controller determines whether to perform the processing to generate the image forming condition based on the result of the second pattern image read by the reader, the second pattern image being on the second recording medium, based on results of a plurality of areas read by the reader, the plurality of areas being on the first recording medium, the plurality of areas in which the first pattern image is not formed.

6. The image forming apparatus according to claim 5, wherein the plurality of areas includes a first area and a second area different from the first area in the conveyance direction.

7. The image forming apparatus according to claim 1, wherein, with a difference in density detected by the reader between a plurality of areas on the first recording medium greater than or equal to a threshold, the plurality of areas in which the first pattern image is not formed, the controller does not generate the image forming condition based on the reading result of the second pattern image read by the reader, the second pattern image being on the second recording medium, the second recording medium on which the second image is formed.

8. The image forming apparatus according to claim 1,
wherein the image forming unit includes a light source configured to expose a photosensitive member to a laser beam to form an electrostatic latent image, and a development roller configured to develop the electrostatic latent image on the photosensitive member, and
wherein the image forming condition includes intensity of the laser beam.

9. The image forming apparatus according to claim 1, wherein the image forming unit includes a conversion unit configured to convert image data based on a conversion condition as the image forming condition.

10. A method comprising:
forming an image on an image carrier based on an image forming condition;
transferring the image from the image carrier to a recording medium;
fixing the image on the recording medium by a fixing unit;
reading the image on the recording medium downstream of the fixing unit in a conveyance direction in which the recording medium is conveyed; and
controlling the forming to form the image and a pattern image;
controlling the transferring to transfer the image and the pattern image to a same recording medium;
the fixing to fix the image and the pattern image on the same recording medium;
controlling the reading to read the pattern image on the same recording medium; and
generating the image forming condition based on a result of the pattern image read by the reading,
wherein, in a case where a plurality of images is formed on a plurality of recording media of a same type, the controlling acquires a result of a first recording medium read by the reading, the first recording medium on which a first image included in the plurality of images and a first pattern image are formed, and determines, based on the result of the first recording medium, whether to perform processing to generate the image forming condition based on a result of a second pattern image read by the reading, the second pattern image being on a second recording medium, the second recording medium on which a second image included in the plurality of images is to be formed, the second recording medium being subsequent to the first recording medium.

11. The method according to claim 10, wherein, in response to determination by the controlling not to perform the processing to generate the image forming condition based on the result of the second pattern image, the second pattern image being on the second recording medium, the second recording medium on which the second image is to be formed, the controlling controls the forming not to form the second pattern image, or the controlling controls the reading not to read the second pattern image on the second recording medium.

12. The method according to claim 10, further comprising measuring an image on the image carrier,
wherein, in response to determination by the controlling not to perform the processing to generate the image forming condition based on the result of the second pattern image, the second pattern image being on the second recording medium, the controlling controls the forming to form the image, controls the measuring the image, and generates the image forming condition based on a measurement result of the image.

13. The method according to claim 10, wherein the controlling determines whether to perform the processing to generate the image forming condition based on the result of the second pattern image, the second patter image being on the second recording medium, based on results of a plurality of areas read by the reading, the plurality of areas being on the first recording medium, the plurality of areas in which the first pattern image is not formed.

14. The method according to claim 10, wherein, with a difference in density detected by the reading between a plurality of areas on the first recording medium greater than or equal to a threshold, the plurality of areas in which the first pattern image is not formed, the controlling does not generate the image forming condition based on the reading result of the second pattern image, the second pattern image being on the second recording medium, the second recording medium on which the second image is formed.

15. The method according to claim 10,
wherein the forming includes exposing a photosensitive member to a laser beam to form a latent image, and developing the latent image on the photosensitive member, and
wherein the image forming condition includes intensity of the laser beam.

16. A non-transitory computer readable storage medium storing a program for causing a computer to perform control of a method, the method comprising:
forming an image and a pattern image on a same recording medium by using a printer;
reading the pattern image on the same recording medium; and
generating an image forming condition for the printer based on a result of the pattern image read by the reading,
wherein, in a case where a plurality of images is formed on a plurality of recording media of a same type, acquiring a result of a first recording medium read by the reading, the first recording medium on which a first image included in the plurality of images and a first pattern image are formed, and determining, based on the result of the first recording medium, whether to perform processing to generate the image forming condition based on a result of a second pattern image read by the reading, the second pattern image being on a second recording medium, the second recording medium on which a second image included in the plurality of images is to be formed, the second recording medium being subsequent to the first recording medium.

17. The non-transitory computer readable storage medium according to claim 16, wherein, in response to the determining not to perform the processing to generate the image forming condition based on the result of the second pattern image, the second pattern image being on the second recording medium, the second recording medium on which the second image is to be formed, the controlling controls the forming not to form the second pattern image, or the controlling controls the reading not to read the second pattern image on the second recording medium.

18. The non-transitory computer readable storage medium according to claim 16, further comprising measuring an image on the image carrier,
wherein, in response to the determining not to perform the processing to generate the image forming condition based on the result of the second pattern image, the second pattern image being on the second recording medium, the controlling controls the forming to form the image, controls the measuring the image, and generates the image forming condition based on a measurement result of the image.

19. The non-transitory computer readable storage medium according to claim 16, wherein the determining whether to perform the processing to generate the image forming condition based on the result of the second pattern image, the second patter image being on the second recording medium, based on results of a plurality of areas read by the reading, the plurality of areas being on the first recording medium, the plurality of areas in which the first pattern image is not formed.
